(19) United States
(12) Patent Application Publication
(10) Pub. No.: US 2010/0187298 A1
(43) Pub. Date: Jul. 29, 2010

(54) DRINKING VESSEL THAT HAS A SLOT IN WHICH A CONTACTLESS SMART CARD IS INSERTED

(76) Inventors: Simon Phillips, York (GB); James J. Anderson, Mount Vernon, NY (US)

Correspondence Address: BUCKLEY, MASCHOFF & TALWALKAR LLC, 50 LOCUST AVENUE, NEW CANAAN, CT, 06840, US

(21) Appl. No.: 12/359,451

(22) Filed: Jan. 26, 2009

(51) Int. Cl. G06F 19/00

(52) U.S. Cl. 235/375

(57) ABSTRACT

A food container is in combination with a contactless smart card. The food container has a slot formed therein. The slot is shaped and sized to hold the smart card. The smart card was inserted into the slot.

### BACKGROUND

Proximity payment devices are well-known. For example, card-shaped proximity payment devices (sometimes referred to as “contactless payment cards”) incorporate a radio frequency identification (RFID) integrated circuit (IC) and an antenna. Such devices may be used in place of a conventional magnetic stripe credit or debit card to pay for purchase transactions. In operation, the device is tapped on a proximity reader component of a POS terminal. When this occurs, the RFID IC receives an interrogation signal from the proximity reader and uploads the user's payment card account number to the POS terminal through the proximity reader via wireless RF signaling.

MasterCard International Incorporated, the assignee hereof, has established a widely-used standard, known as “PayPass”, for interoperability of contactless payment cards and proximity readers.

It has also been proposed to provide proximity payment devices in form factors that are not card-shaped. Keyfob proximity payment devices have been proposed, and it has also been proposed to incorporate proximity payment capabilities in wristwatches, mobile telephones, etc.

Proximity payment devices often provide enhanced convenience in carrying out transactions, as compared to conventional magnetic stripe payment cards. However, the present inventor has observed that it may be desirable to aspire to still greater convenience. For example, payment transactions may entail awkward fumbling and delay, in removing a proximity payment card or payment-enabled mobile telephone from a pocket, purse or wallet, when an individual is in a hurry, and/or is encumbered with packages, an umbrella, a handbag, an item to be purchased, etc.

### BRIEF DESCRIPTION OF THE DRAWINGS

FIG. 1 schematically illustrates a drinking mug having a proximity payment card inserted therein in accordance with aspects of the present invention.

FIG. 2 schematically illustrates another manner of associating a proximity payment card with a drinking mug in accordance with other aspects of the present invention.

FIG. 3 is a partial and schematic sectional view of the drinking mug of FIG. 2, taken at line III-III in FIG. 2.

FIG. 4 is a schematic plan view of an example of the proximity payment card seen in FIGS. 1-3.

FIG. 5 is a block diagram representation of a beverage dispenser that may be operated with the drinking mugs of FIGS. 1-3 in accordance with aspects of the present invention.

FIG. 6 is a flow chart that illustrates a process that may be performed to assemble and use a payment-enabled drinking mug in accordance with aspects of the present invention.

### DETAILED DESCRIPTION

In general, and for the purpose of introducing concepts of embodiments of the present invention, a proximity payment card is inserted in a slot in a drinking mug or otherwise secured to or associated with a drinking mug. The proximity payment card may function as a stored value card or alternatively as a credit or debit card. The combination of a drinking mug with a proximity payment card may facilitate payment for and dispensing of drinks at a pub, a sports venue, etc. In some embodiments, the mug/payment card combination may allow for automatic dispensing of and payment for beverages, thereby reducing labor costs and increasing efficiency in crowded situations.

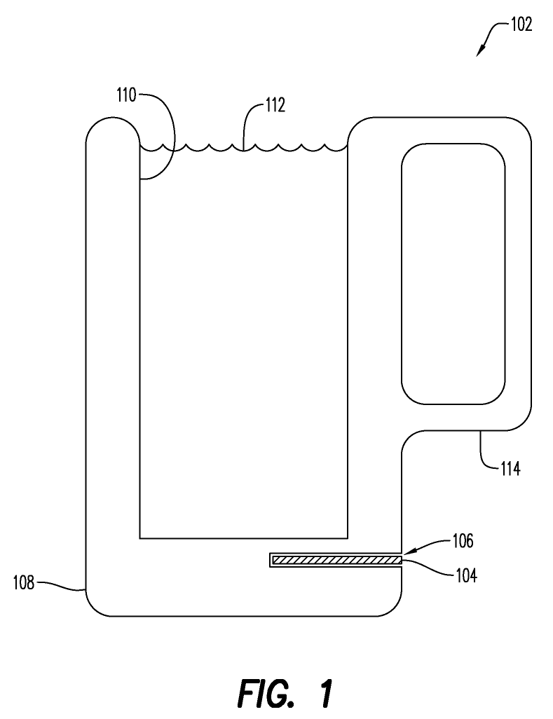

FIG. 1 schematically illustrates a drinking mug 102 having a proximity payment card 104 inserted therein in accordance with aspects of the present invention. The drinking mug 102 may be conventional except that it has a slot 106 formed in its base 108. The slot 106 is shaped and sized to receive and hold the proximity payment card 104, and it will be noted from FIG. 1 that the proximity payment card 104 has been inserted into the slot 106. In other embodiments, the slot may be formed in a part of the drinking mug 102 other than its base. It will be noted that the cavity 110 of the drinking mug 102 has been filled with a beverage 112. The drinking mug 102 also includes a handle 114, but in other embodiments of the invention, there is no handle so that the drinking vessel in question may be a glass or cup rather than a mug. The drinking vessel/mug may be formed in whole or in part of glass, plastic, ceramic, metal or any other suitable material.

Details of the proximity payment card 104 will be provided below.

The drinking mug/payment card arrangement shown in FIG. 1 may be advantageous as compared to physically embedding RFID elements in a drinking vessel as proposed in U.S. published patent application no. 2006/0180647. With the payment card inserted in the slot of the mug as in the embodiment of FIG. 1 herein, the necessary writing of information into the card may occur prior to insertion by a generally conventional “personalization” process (which is discussed further below). By contrast, handling of the cup and/or RFID element as proposed in the '647 published patent application may prove inconvenient and efficient when it is desired to store information in the RFID element prior to use.

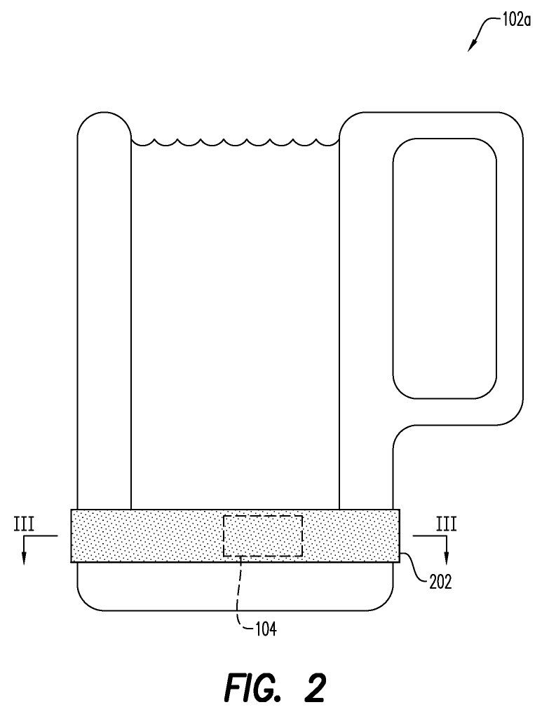

FIG. 2 schematically illustrates another manner of associating a proximity payment card 104 with a drinking mug 102a in accordance with other aspects of the present invention.

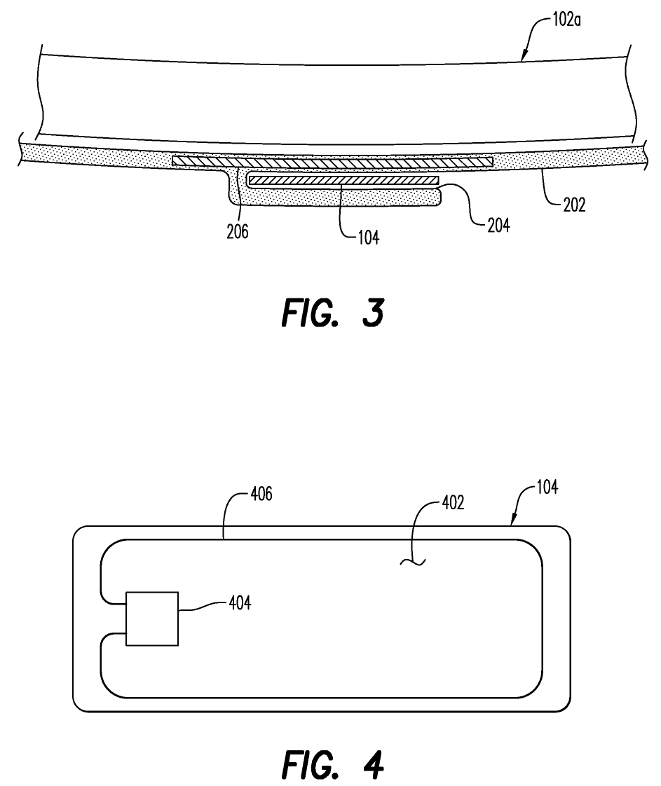

In the embodiment of FIG. 2, the mug 102a itself may be entirely conventional. However, a sleeve or band 202 may, in accordance with aspects of the present invention, be secured or affixed around the mug 102a (e.g., near the bottom of the mug, as shown). The sleeve or band 202 may be substantially cylindrical in shape and may be generally elastic, or may incorporate elastic material, so that it may retain its position around the mug 102a, though subject to being intentionally removed by a user by sliding off toward the bottom of the mug 102a. The sleeve or band 202 may include a pocket 204 (seen in FIG. 3; the pocket may also be referred to as a “slot”), that is shaped and size to receive and hold the proximity payment card 104.

(As used herein and in the appended claims, the term “affixed” includes being secured to an object by frictional and/or elastic forces, by snap-fitting, by adhesive or in other ways.)

The sleeve or band 202 may include a layer 206 (FIG. 3) of ferrite or other ferromagnetic material. This layer 206 may be referred to as a “shield layer” and may provide the benefit of shielding the proximity payment card 104 from interfering effects in the situation where the mug 102a is formed of metal, thereby shielding communications to the proximity payment card 104 from interference from the mug 102a. The shield layer 206 may be located adjacent the pocket or slot 204 and may have a planar extent that is somewhat larger than the planar extent of the pocket or slot 204 and of the proximity payment card 104 in both the length and width directions of the proximity payment card 104.

With a sleeve or band as shown in FIGS. 2 and 3, a conventional drinking vessel may be retrofitted to permit convenient and semi-permanent association of a proximity payment card with the drinking vessel. Consequently, it is not necessary to have a slot formed in the drinking vessel in order to obtain the aforementioned advantages as are realized by the embodiment of FIG. 1.

In alternative embodiments, an object other than a sleeve or band may be affixed to a drinking vessel, with a slot in the object to hold a proximity payment card. For example, the object may be a sticker/card holder as disclosed in a prior application (by the present inventor, and commonly assigned herewith) filed Jul. 27, 2007, and assigned application Ser. No. 11/829,165. The disclosure of the '165 application is incorporated herein by reference. In another possible form, the object may be formed of rigid or semi-rigid plastic and may snap-fit onto the drinking vessel.

In still another embodiment, the proximity payment card may itself include an adhesive layer by which it is affixed to the drinking vessel (e.g., the proximity payment card may be a sticker that can be adhered to the drinking vessel).

FIG. 4 is a schematic plan view of an example of the proximity payment card 104 shown in FIGS. 1-3. As seen from FIG. 4, the proximity payment card 104 includes a card-shaped body 402 (e.g., laminated from layers of plastic) in which an RFID (radio frequency identification) chip 404 (IC or integrated circuit) is embedded. An antenna 406 is embedded in the card-shaped body 402 and runs along the periphery of the card-shaped body 402. (Although the antenna 406 is shown as having only one turn, in some embodiments the antenna 406 may include two or more turns.) The antenna 406 is coupled to the RFID chip 404 to allow the RFID chip 404 to receive interrogation signals from proximity reader devices. The antenna 406 also allows the RFID chip to transmit payment card account information and/or other information to the reader devices. The proximity payment card 104 may be constructed and may operate in accordance with conventional practices. For purposes of illustration, the RFID chip and antenna are shown in FIG. 4, but in practical examples of the proximity payment card 104 the card body may be formed largely of opaque plastic and the RFID chip and antenna may be embedded in the opaque plastic so as not to be visible. Instead, the proximity payment card 104 may display branding or other printed information.

Reference was made above to the process of “personalizing” the proximity payment card 104. As is familiar to those who are skilled in the art of proximity payment cards, during personalization, card specific information is wirelessly written into the card's RFID chip, and may also be printed on the card. In accordance with prior proposals, the process of personalization may be simplified by initially providing the card blank for the proximity payment card 104 as part of an ID-1 sized assembly that includes scoring or the like to define the card (sometimes referred to as a “subcard”) within the ID-1 sized footprint of the assembly. (As is well known to those who are skilled in the art, the ID-1 standard for identification cards defines the shape and dimensions of the most widely used magnetic stripe payment and ATM cards. The planar extent of an ID-1 card is substantially 85.6 mm long by 54 mm wide.) The ID-1 sized assembly may then be processed for purposes of personalizing the card blank using the same standard types of personalization equipment conventionally used to personalize ID-1 sized contactless payment cards. (One example of a suitable ID-1 sized assembly—which includes a RFID IC subcard that may be detached from the assembly—is shown in FIG. 1 of a commonly-assigned patent application that has been published as U.S. published patent application no. 2008/0121707.)

In some embodiments, the size of the proximity payment card 104 may be similar to the size of a conventional SIM (subscriber identification module) card or may be somewhat larger, including up to a size that has a length equal to the width of an ID-1 card and a width equal to one-fifth to one-third of the length of an ID-1 card. Other sizes are also possible for the proximity payment card 104, including the size of an ID-1 card.

In some embodiments, the proximity payment card 104 may be a branded payment card such as a MasterCard® credit or debit card and may be configured to operate in accordance with the well-known PayPass standard. In other embodiments, the proximity payment card 104 may operate as a branded or unbranded stored value card.

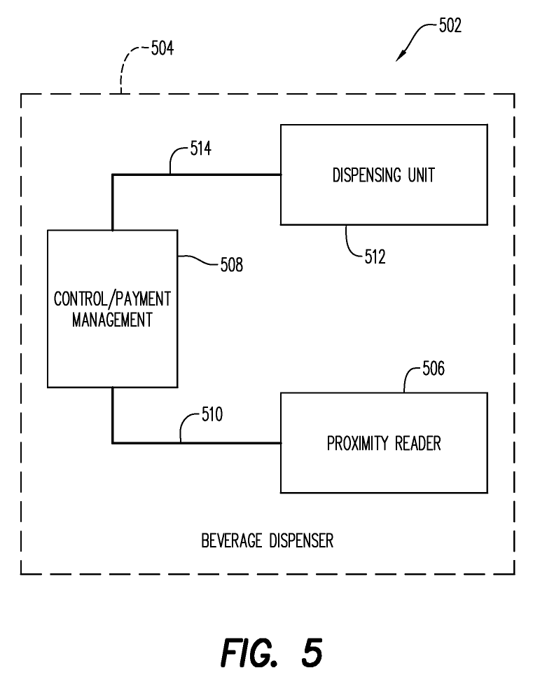

FIG. 5 is a block diagram representation of a beverage dispenser 502 that may be operated with the drinking mugs of FIGS. 1-3 in accordance with aspects of the present invention.

The beverage dispenser 502 may include a plastic and/or metal housing 504, which is indicated in phantom. The beverage dispenser 502 may further include, in a lower portion of the housing 504, a proximity reading device 506. The proximity reading device 506 may be programmed and/or configured so as to interact with proximity payment cards, such as those described hereinabove. For example, the proximity reading device 506 may repeatedly transmit, over a short distance and at frequent intervals, an interrogation signal to stimulate a nearby proximity payment card to transmit back payment information, such as a payment card account number stored in the proximity payment card. For example, the proximity reading device 506 may operate in accordance with the above-mentioned “PayPass” standard. In other embodiments, wherein the proximity payment cards function as stored value cards, the proximity reading device 506 may interact with the proximity payment card to cause an amount of money to be debited from the funds stored in the proximity payment card to implement payment for a beverage to be dispensed by the beverage dispenser 502.

The beverage dispenser 502 may further include a control/payment management circuit 508. The control/payment management circuit 508 may be in communication with the proximity reading device 506 (via a signal path 510) and may control the overall operation of the beverage dispenser 502. In some embodiments, for example, the control/payment management circuit 508 may be constituted by a conventional control device (not separately shown), such as a microprocessor or microcontroller, coupled to a memory device (e.g., ROM; not separately shown) which stores program instructions that control operation of the control device.

In addition, the beverage dispenser 502 includes a dispensing unit 512 which, under the control of the control/payment management circuit 508, selectively dispenses one or more beverages such as beer, soda or other drinks. The dispensing unit 512 may include one spout or nozzle or two or more spouts or nozzles. The housing 504 may be configured, and the proximity reading device 506 and the dispensing unit 512 may be located, such that, when the bottom of a drinking vessel (not shown in FIG. 5) is above and adjacent to the proximity reading device 506, the open top of the drinking vessel is below the dispensing unit 512 so that a beverage dispensed from the dispensing unit 512 flows down into the drinking vessel.

The dispensing unit 512 may receive control signals from the control/payment management circuit 508 via a signal path 514. In addition, in some embodiments, the dispensing unit 512 may send status signals to the control/payment management circuit 508 via the signal path 514. The dispensing unit 512 may include one or more reservoirs (not separately shown) for holding a supply of a beverage or beverages to be dispensed by the dispensing unit 512. In effect, the beverage dispenser 502 may function as an intelligent bar tap, as well as, possibly, a point of sale terminal.

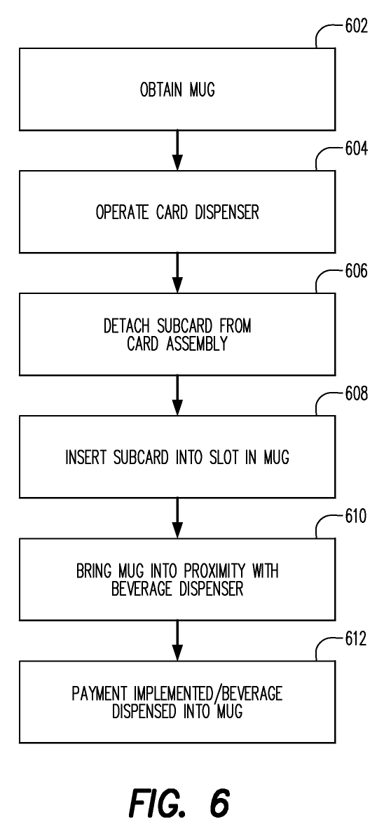

FIG. 6 is a flow chart that illustrates a process that may be performed to assemble and use a payment-enabled drinking mug in accordance with aspects of the present invention. As will be seen, the process of FIG. 6 may also entail operation of a beverage dispenser such as that described above in connection with FIG. 5.

At 602 in FIG. 6, a user obtains a mug 102 (as shown in FIG. 1) or a mug 102a with a sleeve 202 on it (as shown in FIG. 2). In some embodiments, the mug may include words and/or graphics/logos so that it may function as a souvenir or commemorative item. For example, the mug may display a sports team logo, the logo of a major sporting event, a world's fair logo, an amusement park logo, the logo of the brand of a beer, soda or other beverage, etc. In some embodiments, the user may obtain the mug by purchasing it over the counter at a concession stand at a sports arena. In other embodiments, the user may obtain the mug without charge by redeeming customer loyalty points or otherwise in connection with a product or store loyalty program.

In other embodiments, the mug may be a piece of glassware in use at a pub, and may carry printing on it that identifies the pub. In this case, the mug may be loaned to the user for the duration of his/her stay at the pub, and the user would not be required to purchase the mug.

At 604 in FIG. 6, the user interacts with a vending machine (not shown) in order to obtain the proximity payment card 104 that is to be inserted in the slot of the mug or sleeve (as the case may be). The vending machine may dispense the proximity payment card 104 as part of an assembly, as described above, from which the proximity payment card may be detached. Before being loaded into the vending machine, the assembly may have been processed in conventional personalization processing equipment (not shown) so as to load the subcard with payment information, such as a payment card account number, or with monetary value in accordance with a stored value card scheme. The user may obtain the assembly, for example, by inserting cash payment into the vending machine. (In another embodiment, a sales clerk may sell the mug and the subcard assembly to the user in a single transaction over the counter.)

At 606 in FIG. 6, the user detaches the subcard from the assembly so that the proximity payment card 104/subcard is available for insertion into the slot 106 in the mug 102 or the slot/pocket 204 in the sleeve 202, as the case may be. Then, at 608, the user inserts the proximity payment card 104 into the slot 106 or 204. (Alternatively, one or both of these two steps 606 may be performed by a sales clerk/serving employee (e.g., a bartender)).

At 610, the user brings the mug (with the proximity payment card 104 attached thereto) into proximity with the beverage dispenser 502, and more particularly brings the part of the mug where the proximity payment card 104 is located into proximity with the proximity reading device 506 of the beverage dispenser 502. Wireless communication (e.g., via RF) then ensues (as per step 612, FIG. 6) between the proximity reading device 506 of the beverage dispenser 502 and the proximity payment card 104 that has been secured to the mug 102 or 102a. For example, the proximity reading device 506 of the beverage dispenser 502 may transmit an interrogation signal that is received by and powers up the proximity payment card 104. In response to the interrogation signal, the proximity payment card 104 may transmit a payment card account number to the proximity reading device 506 of the beverage dispenser 502, and the beverage dispenser 502 may initiate a purchase transaction in a payment card system (not shown; communication components of the beverage dispenser are also not shown) via the control/payment management circuit 508. As a result of the purchase transaction, the user's payment card account may be charged or debited for the purchase price of a serving of the beverage to be dispensed by the beverage dispenser 502. Alternatively, the exchange of communications between the proximity payment card 104 and the proximity reading device 506 of the beverage dispenser 502 may result in the purchase price being deducted from monetary value stored in the proximity payment card 104, and in the beverage dispenser 502 being informed that this deduction in value has occurred. In any event, once the payment has been implemented through the interaction between the proximity payment card 104 and the beverage dispenser 502, the dispensing unit 512 dispenses a measured amount of beverage into the cavity 110 (FIG. 1) of the drinking mug 102 or 102a.

In some embodiments, a server employee may perform step 610 and may hold the mug in a suitable position relative to the beverage dispenser 502 while step 612 (the interaction between the mug/proximity payment card and the beverage dispenser) takes place. In other embodiments, as noted above, the customer/user may perform step 610 and hold the mug in the necessary position, so that beverage dispensing and payment for the beverage serving occur on a self-service basis.

In some embodiments, the proximity payment card 104 may store information that indicates the volumetric capacity of the mug. In these embodiments, the beverage dispenser may read the capacity information from the proximity payment card and the dispensing unit may be controlled accordingly by the control/payment management circuit 508 to dispense the suitable quantity of beverage to match the indicated capacity of the mug. In some embodiments, the card may only provide the capacity information, and may have no functionality with respect to payment, in which case the card may not be considered to be a payment card, but rather is a contactless smart card that provides control information. (Whether or not the card provides payment functionality, and whether or not it implements this quantity control function, the card may be referred to as a “contactless smart card”.)

In some embodiments, the proximity payment card 104 may store information that indicates the user's preference as to type, variety and/or brand of beverage. For example, this information (which may be referred to as “beverage type information”) may indicate a specific brand and variety of beer, such as “Bud Light”, that the user wishes to be dispensed into the drinking mug. In these embodiments, the beverage dispenser may read the beverage type information from the proximity payment card (which may not also include payment functionality and hence may, in some cases, not be referred to as a proximity payment card). The dispensing unit may be controlled by the control/payment management circuit 508 in accordance with the beverage type information read from the proximity payment card to select the specific variety of beverage to be dispensed from among several beverage types available for dispensing from the beverage dispenser.

In some embodiments, the process of FIG. 6 may be applied to dispensing a hot drink such as tea or coffee, and the proximity payment card 104 (which again need not include payment functionality or be referred to as a proximity payment card) may store information that is indicative of a substance (such as sugar, milk or powdered creamer) that is to be added to the beverage (e.g., after the beverage has been dispensed into the mug) by the beverage dispenser. This information may be referred to as “condiment information” and may be read from the proximity payment card by the beverage dispenser to select the indicated condiment for being automatically dispensed into the drinking mug before or after dispensing the beverage into the drinking mug.

In some embodiments, the proximity payment card may store information that indicates the age and/or the date of birth of the user. In these embodiments, the beverage dispenser 502 may read the age/DOB information from the proximity payment card and may interlock the dispensing unit 512 so as to prevent dispensing of alcoholic beverages to the user if the age/DOB information indicates that the user is not old enough to legally consume alcoholic beverages.

In some embodiments, the present invention may be applied in a hotel or resort, and the proximity payment card may store, and transmit to the beverage dispenser, the user's room or suite number in lieu of a payment card account or stored monetary value. In this way, based on information read from the proximity payment card, drinks dispensed to the user may be charged to the user's room account.

The association of a proximity payment card with a drinking mug (with or without further information stored in the card, such as information that identifies the user's preferred drink) makes feasible a number of advantageous applications of the present invention. For example, in a pub environment, each customer may be issued a mug-with-payment-card at the time the customer enters the pub. This may be done in return for a cash payment from the customer in which the customer pays in advance for a certain number of fills of the mug. This number of fills may be the maximum limit for the number of drinks that the pub wishes to serve to a given customer in the course of one evening. (In return for advance payment, the amount of the payment may represent a discount from the normal per-drink price.) The mug may be issued to the customer with the first drink having been dispensed therein. For the dispensing of that drink and the subsequent drinks, the pub employee may bring the mug in proximity to a beverage dispensing device. The beverage dispensing device may interact with the proximity payment card to count down to the final drink for that customer for the evening; for example, the proximity payment card may store data, rewriteable by the beverage dispensing device, to indicate how many drinks remain to be dispensed for the customer. As will be understood from the above discussion of FIG. 5, the beverage dispensing device also dispenses the beverage (e.g., beer or ale) in response to detecting the presence of the proximity payment card. In some applications, the customer rather than the pub employee may bring the mug-plus-card into proximity with the beverage dispenser, and the beverage dispenser will automatically cut off the customer from further drinking when the drink limit administered through the card is reached. In either case, the mug-plus-card arrangement may significantly streamline dispensing of, and payment for, drinks.

The above embodiments have been described in terms of dispensing beverages into a drinking vessel. However, in further embodiments, the invention may be applied to food containers other than drinking vessels. For example, the food container may be a bowl or dish rather than a drinking vessel, and solid food (e.g., a sandwich, a hamburger, a salad, etc.) may be automatically dispensed into the food container by a food dispensing device in response to payment or other interaction between the dispensing device and a proximity payment card or other type of contactless smart card associated with the food container.

In some embodiments, the food container/drinking vessel may be collapsible.

The above descriptions of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. In combination, a food container and a contactless smart card, the food container having a slot formed therein, the slot shaped and sized to hold the smart card, the smart card having been inserted into the slot.

2. The combination according to claim 1, wherein the food container is a drinking vessel.

3. The combination according to claim 2, wherein the drinking vessel is a drinking mug.

4. The combination according to claim 2, wherein the contactless smart card is configured to transmit payment information to implement payment for a beverage to be dispensed into the drinking vessel.

5. The combination according to claim 2, wherein the contactless smart card stores data indicative of a volumetric capacity of the drinking vessel, the contactless smart card programmed to transmit said data to a beverage-dispensing device.

6. The combination according to claim 2, wherein the contactless smart card stores data indicative of a type of beverage to be dispensed into the drinking vessel, the contactless smart card programmed to transmit said data to a beverage-dispensing device.

7. The combination according to claim 2, wherein the contactless smart card stores data indicative of the age of an individual who holds the drinking vessel, the contactless smart card programmed to transmit said data to a beverage-dispensing device.

8. The combination according to claim 2, wherein the contactless smart card stores data indicative of at least one substance to be added to a beverage dispensed into the drinking vessel, the contactless smart card programmed to transmit said data to a beverage-dispensing device.

9. In combination, a food container, an object affixed to the food container, and a contactless smart card, said object affixed to the food container having a slot formed therein, the slot shaped and sized to hold the smart card, the smart card having been inserted into the slot.

10. The combination according to claim 9, wherein the food container is a drinking vessel.

11. The combination according to claim 10, wherein the drinking vessel is a drinking mug.

12. The combination according to claim 10, wherein the contactless smart card is configured to transmit payment information to implement payment for a beverage to be dispensed into the drinking vessel.

13. The combination according to claim 10, wherein the contactless smart card stores data indicative of a volumetric capacity of the drinking vessel, the contactless smart card programmed to transmit said data to a beverage-dispensing device.

14. The combination according to claim 10, wherein the contactless smart card stores data indicative of a type of beverage to be dispensed into the drinking vessel, the contactless smart card programmed to transmit said data to a beverage-dispensing device.

15. The combination according to claim 10, wherein the contactless smart card stores data indicative of the age of an individual who holds the drinking vessel, the contactless smart card programmed to transmit said data to a beverage-dispensing device.

16. The combination according to claim 10, wherein the contactless smart card stores data indicative of at least one substance to be added to a beverage dispensed into the drinking vessel, the contactless smart card programmed to transmit said data to a beverage-dispensing device.

17. The combination according to claim 9, wherein the object includes a shield layer positioned adjacent said slot, said shield layer for shielding communications to said contactless smart card from interference from said food container.

18. A method comprising:
obtaining a drinking vessel;
obtaining a contactless smart card; and
removably inserting the contactless smart card into a slot in the drinking vessel.

19. The method of claim 18, wherein the step of obtaining the contactless smart card includes:
receiving, from a card dispensing device, a card-shaped assembly that includes the contactless smart card; and
detaching the contactless smart card from the card-shaped assembly.

20. The method of claim 18, further comprising:
after said inserting step, bringing the drinking vessel and the contactless smart card into proximity with a beverage-dispensing device to implement payment for a beverage to be dispensed into the drinking vessel by the beverage-dispensing device.

21. The method of claim 18, further comprising:
after said inserting step, bringing the drinking vessel and the contactless smart card into proximity with a beverage-dispensing device to control operation of the beverage-dispensing device.
